(19) United States
(12) Patent Application Publication
(10) Pub. No.: US 2012/0166774 A1
(43) Pub. Date: Jun. 28, 2012

(54) COMPUTER-READABLE MEDIUM STORING PROCESSOR TESTING PROGRAM

(75) Inventor: Masayuki TSUJI, Yokohama (JP)

(73) Assignee: Fujitsu Semiconductor Limited, Yokohama-shi (JP)

(21) Appl. No.: 13/281,074

(22) Filed: Oct. 25, 2011

(30) Foreign Application Priority Data
Dec. 28, 2010 (JP) 2010-292942

(51) Int. Cl. G06F 9/30

(52) U.S. Cl. 712/227; 712/E09.032

(57) ABSTRACT

A non-transitory computer-readable medium storing a processor testing program causing a computer to execute a testing process for a processor, the processor having a plurality of pipeline stages for processing an instruction and a controller for providing the pipeline stage with an inter-lock signal for aborting a transition of the instruction between the pipeline stages when a pipeline hazard is expected to occur. The testing process has a timing generating process including: referring to a pipeline-stage combination pattern indicating whether or not an instruction is under process at each pipeline stage and prescribes a processing status to be tested, and timing generating which provides the inter-lock signal, while an instruction included in a test instruction sequence is executed, so that a processing status of the instruction is matched with the processing status to be tested according to an status information.

### CROSS-REFERENCE TO RELATED APPLICATION

This application is based upon and claims the benefit of priority of the prior Japanese Patent Application No. 2010-292942, filed on Dec. 28, 2010, the entire contents of which are incorporated herein by reference.

### FIELD

Embodiments discussed herein relate to a computer-readable medium storing a processor testing program.

### BACKGROUND

In recent years, for the purpose of enabling a multi-cored processor, there are increasing number of examples of using an application specific processor (ASP). ASP is a processor, specifically designed for an application executed by a user, which has dedicated instructions for processing the application at high-speed.

It is not easy to generate an ASP at each time a user designs a system for executing an application. However, for example, there is provided such a specific purpose description language as LISA or the like (refer to “Architecture Exploration for Embedded Processors with LISA”, written by Andreas Hoffmann). A user describes definitions of architecture of a processor by using LISA, and converts it into RTL (Register Transfer Level) of the processor by a dedicated compiler, to design an ASP. Thereby, the user decreases work-processes required for designing an ASP. However, for an automatically generated ASP, testing thereof is necessary, and tremendous work-processes are required for the testing.

Also, for a processor of recent years having instruction pipelines, for example, at the time of predicting a occurring of a pipeline hazard, testing whether or not an appropriate inter-lock signal is output, a bypass circuit appropriately operates, or the like, is necessary. For that purpose, the user manually generates, for example, a processing status of an instruction at pipeline stages, by which an inter-lock signal is output, or a processing status of an instruction at pipeline stages, by which a bypass circuit operates, and tests at the processing status whether or not an appropriate an operation is performed.

In an example of generating a processing status of a couple of consecutive instructions executed at pipeline stages next to each other, the user confirms, by executing an instruction sequence that a pipeline stall does not occur, whether or not an anticipated processing status to be tested is generated. Also, for example, in case of generating a processing status by which a couple of consecutive instructions are executed at pipeline stages with an interval of one pipeline stage, the user makes an adjustment such as adding a NOP instruction in between the couple of instructions, and confirms, by a similar simulation, whether or not the anticipated processing status to be tested is generated. In this manner, tremendous work-processes are required for testing the processor having instruction pipelines.

Japanese Patent Application Laid-Open Publication No. 2001-273340 discloses an example of decreasing the work-process required for testing a processor.

### SUMMARY

It is difficult for a known testing apparatus to automatically control the pipeline stage of the processor into a processing status for testing.

In accordance with an embodiment, a non-transitory computer-readable medium storing a processor testing program causing a computer to execute a testing process for a processor, the processor having a plurality of pipeline stages for processing an instruction and a controller for providing the pipeline stage with an inter-lock signal for aborting a transition of the instruction of the instruction between the pipeline stages when a pipeline hazard is expected to occur. The testing process comprising: referring to a pipeline-stage combination pattern indicating whether or not an instruction is under process at each pipeline stage and prescribes a processing status to be tested at the pipeline stages; and timing generating which provides the inter-lock signal to the pipeline stage, while an instruction included in a test instruction sequence is executed, so that a processing status of the instruction at the pipeline stages is matched with the processing status to be tested of the pipeline-stage combination pattern according to an status information indicating whether or not the instruction is under process at each pipeline stage.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a drawing for illustrating a configuration example of a computer having a processor testing program;

FIG. 2 is a drawing for illustrating a configuration example of a test bench;

FIG. 3 is a drawing for illustrating of transition of the pipeline stage at the time of a data hazard and a bypass process;

FIG. 4 is a drawing for illustrating an example of an instruction pipeline of a processor having a DIV stage;

FIG. 6 is a flow-chart diagram for illustrating a test procedure the processor;

FIG. 5 is a drawing for illustrating a pipeline-stage combination pattern table;

FIG. 7 is a drawing for illustrating an example of a test instruction sequence;

FIG. 8 is a drawing for illustrating an example of a timing generating unit;

FIG. 9 is a drawing for illustrating a configuration example of a sequencer;

FIG. 10 is a flow-chart diagram for illustrating a process procedure of the sequencer;

FIG. 11 is a flow-chart diagram or illustrating a control process of the sequencer;

FIG. 12 is a drawing for illustrating a processing status of a pipeline stage and a transition of a basic pattern shift register;

FIG. 13 is a flow-chart diagram for illustrating a process procedure of the sequencer and a TEST2 state;

FIG. 14 is a drawing for illustrating a control for generating a structural hazard;

FIG. 15 is a drawing for illustrating the generation of combination pattern and the test instruction sequence; and

FIG. 16 is a drawing for illustrating a generation of the combination pattern on the basis of a test item.

### DESCRIPTION OF EMBODIMENTS

Embodiments will be described hereinafter according to the drawings. However, it is noted that the technical scope is not limited to the embodiments described below, but covers the matters described in the claims and the equivalents thereof.

A processor testing program in accordance with the present embodiment refers to the pipeline-stage combination pattern, which indicates whether or not the instruction is under process at each pipeline stage and prescribes a processing status to be tested at the pipeline stages And, the processor testing program makes a processing status of the instruction at the pipeline stages matched with the processing status to be tested of the pipeline-stage combination pattern, by providing the inter-lock signal to the pipeline stage according to an status information indicating whether or not the instruction is under process at each pipeline stage, while an instruction included in a test instruction sequence is executed by the processor which is under test.

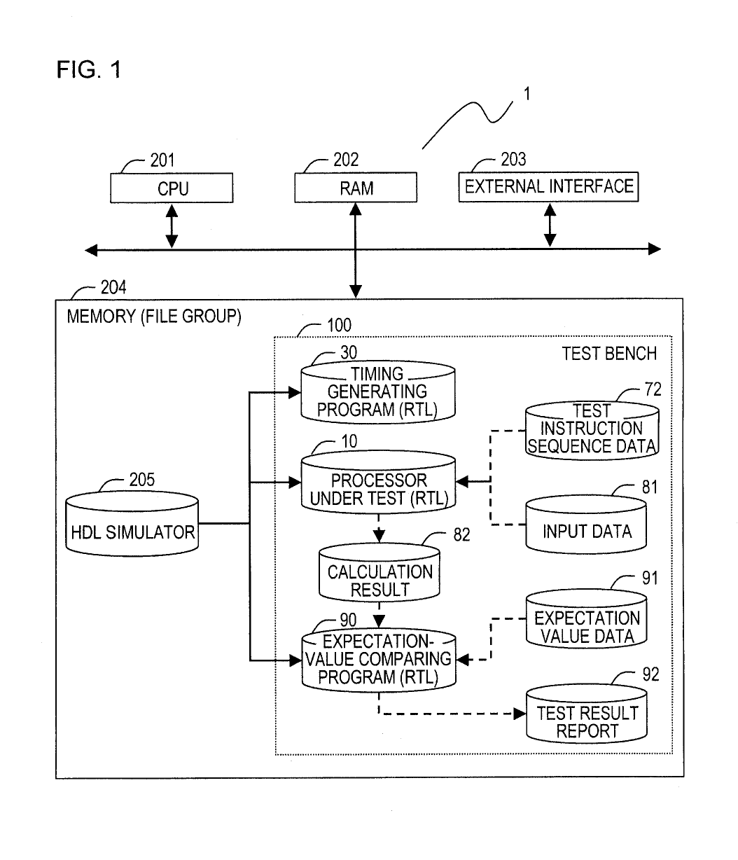

FIG. 1 is a diagram for illustrating a configuration example of a computer 1 having a testing apparatus in accordance with the present embodiment. In FIG. 1, the computer 1 includes a processor 201 thereof, a memory 202 such as RAM (Random Access Memory) or the like, an external interface 203, and a file group 204 stored in the memory. Also, the file group 204 includes an HDL (Hardware Description Language) simulator 205, and a test bench 100 executed by the HDL simulator 205. The HDL simulator 205 performs a test of a processor 10 by executing the processor 10 which is a device under test (DUT) and is described in HDL of an RTL (Register Transfer Level) with the processor 201, according to the test bench 100 in which testing procedures are prescribed.

The test bench 100 of FIG. 1 includes, in addition to the processor-under-test 10, a timing generating program 30 described by RTL, and an expectation value comparing program 90. Also, in the present embodiment, the test bench 100, test instruction sequence data 72, an input data 81, and an expectation value data 91 being as inputs, outputs a calculation result 82 and a test result report 92. The test instruction sequence data 72 includes one instruction code or a plurality of the instruction codes. Also, the expectation value data 91 is a value, which is a calculation result output from the processor-under-test 10 through the execution of the test instruction sequence, the calculation result being forecasted beforehand by the simulator such as ISS (Instruction set simulator).

The timing generating program 30 is a part of the processor testing program in accordance with the present embodiment, and functions as a timing generating unit 30 by being executed by the processor 201 of the computer. The expectation value comparing program 90 also is a part of the processor testing program and functions, in a similar manner, as the expectation value comparing unit 90 by being executed by the processor 201 of the computer. The timing generating unit 30 executed by the processor 201, by providing the inter-lock signal to the processor-under-test 10, matches the processing status of the pipeline stages of the processor 10 with the processing status at the pipeline stages to be tested which is previously prescribed as a test object. Also, the expectation value comparing unit 90 executed by the processor 201 compares a calculation result 82 output by the processor-under-test 10, in which the processing status at the pipeline stages is matched with the processing status to be tested, with the expectation value data 91, and generates the comparison result as the test result report 92. Then, the user determines a test result of the processor 10 on the basis of the test result report 92.

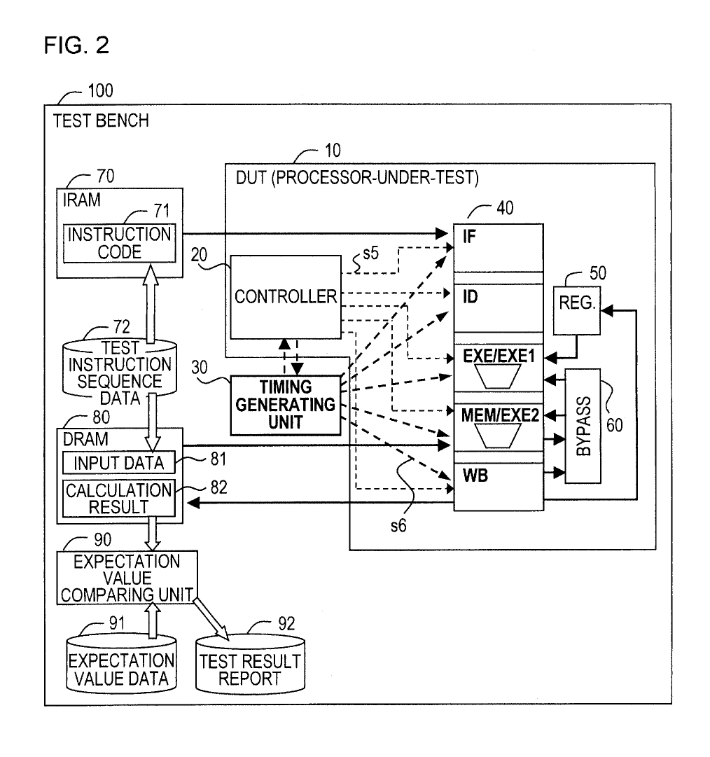

FIG. 2 is a diagram for illustrating a configuration example of the test bench 100 of FIG. 1. The HDL simulator 205 of FIG. 1, at first, sets each instruction code 71 and the input data 81, which is read from the test instruction sequence data 72, on the memory 70 and 80 of the test bench 100. Then, the HDL simulator 205 boots the processor-under-test 10 and has each instruction code 71 pipeline processed, while having the timing generating unit 30 control the processing status of the pipeline stages so as to match with the processing status to be tested.

Also, the processor-under-test 10 of FIG. 2 in accordance with the present embodiment includes a controller 20, an instruction pipeline 40, a register file (Reg) 50, and a bypass circuit 60. Because the timing generating unit 30 is a unit required only at the time of the test, it is provided as a part of the test bench 100 and as the constitution that is different from the processor 10.

In FIG. 2, the instruction pipeline 40 of the processor 10 in accordance with the present embodiment includes, for example, five stages such as “IF”, “ID”, “EXE/EXE1”, “MEM/EXE2”, and “WB”. The IF stage is a stage for performing an instruction fetch. The ID stage is a stage for performing an instruction decode. The EXE/EXE1 stage (referred to as EXE stage, hereinafter) is a stage for executing the instruction (EXE), or executing the first execution of dual stage pipeline processes (EXE1), by reading data from the register file 50 and performing a calculation. And, the MEM/EXE2 stage (referred to as MEM stage, hereinafter) is a stage for reading data (MEM) from DRAM (Dynamic Random Access Memory) 80, or executing the second execution of dual stage pipeline processes (EXE2). The WB stage is a write-back stage for storing a processed result of the instruction into a memory such as DRAM or into the register file 50.

For the processor 10 having such the instruction pipeline 40, there occurs a condition in which, because of dependence relationship between a plurality of the instructions, transitions of some instructions under process at the pipeline stages are required to be aborted (referred to as a “pipeline hazard”, hereinafter). Among pipeline hazards, there are a data hazard, a structural hazard, a control hazard, and the like. Here, the data hazard is explained.

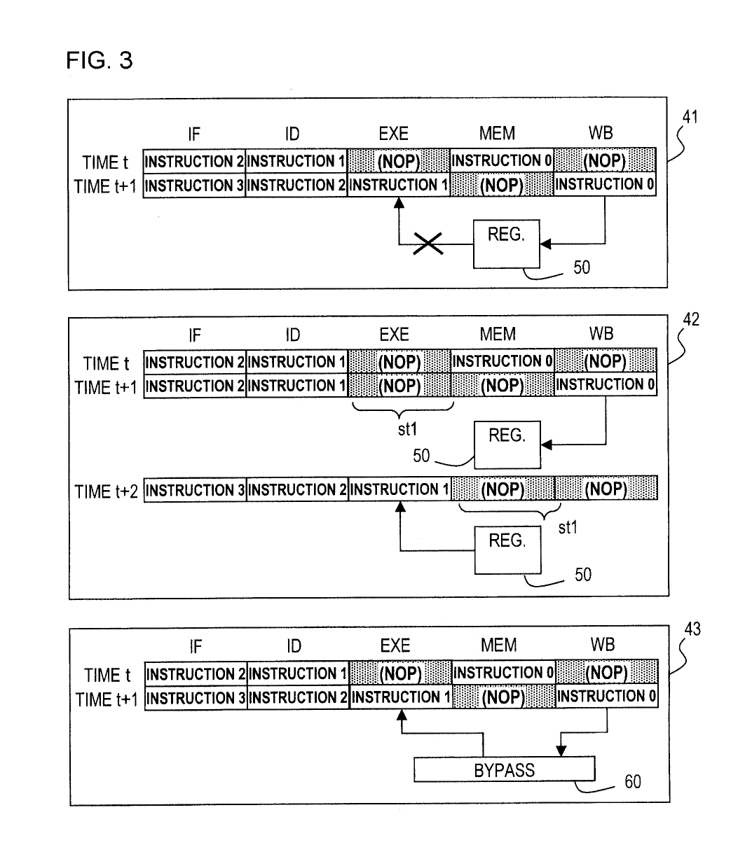

FIG. 3 is a diagram for illustrating transitions of pipeline stages at the time when the data hazard occurs and a bypass process occurs. In transition diagrams 41-43, the horizontal direction represents the pipeline stages, and the vertical direction represents time transitions. An instruction 0 and an instruction 1 are calculation instructions, wherein the instruction 1 performs calculation process by using a calculation result of the instruction 0. In this example, the instruction 0 writes the calculation result to the register file 50 at the WB stage. Then the instruction 1 reads from the register file 50 the calculation result of the instruction 0 at the EXE stage.

The transition diagram 41 of FIG. 3 is a diagram illustrating examples of transitions of the pipeline stages in case of the data hazard occurring. From time t to time t+1, the instruction 0 transits from the MEM stage to the WB stage, and the instruction 1 transits from the ID stage to the EXE stage. However, at the time t+1, since writing of the calculation result of the instruction 0 to the register file 50 is not completed at the WB stage, the instruction 1 can not read from the register file 50 the calculation result of the instruction 0 at the EXE stage. This is a occurring of the data hazard. Here, the processor 10, predicting a occurring of the data hazard at the time t, by providing an inter-lock signal to block the gate from the IF stage and the ID stage to avoid the data hazard to the subsequent pipeline stage, aborts transitions of the instruction 1,2. This is illustrated in the following transition diagram 42.

Transition diagram 42 of FIG. 3 illustrates transitions in case that the inter-lock signal is provided to the IF stage and the ID stage at time t. At time t+1 in FIG. 3, while the instruction 1 and the instruction 2 do not transit by provision of the inter-lock signal, the instruction 0 transits to the WB stage and performs writing of the calculation result into the register file 50. Then, at time t+2, the instruction 1 transits to the EXE stage, and reads the calculation result of the instruction 0 from the register file 50. As a result, the data hazard at time t+1 of transition diagram 41 is avoided.

As above, the processor 10 avoids the data hazard, by providing the inter-lock signal to block transitions of some or all of the instructions in between the pipeline stages. However, transition of the instruction under process is aborted by the inter-lock signal, and the pipeline stall st1 occurs, thus the processing time of instruction being increased. Therefore, there is a case that the processor 10 includes a bypass circuit 60.

The transition diagram 43 of FIG. 3 is a diagram for illustrating an example of the bypass circuit 60. The bypass circuit 60, for example, transfers a calculation result of an instruction processed at a pipeline stage, not through the register file 50, but directly to another pipeline stage. For example, at time t+1 of the transition diagram 43 in FIG. 3, the processor 10 transfers the calculation result of the instruction 0 at the WB stage directly to the EXE stage which is for processing the instruction 1. Thereby, in transition diagram 43, the occurrence of a data hazard is avoided and the pipeline stall st1 does not occur. In the test of processor 10 including the bypass circuit 60, it is necessary to verify whether the bypass processing is appropriately executed.

Further, the processor 10 in accordance with the present embodiment has the bypass circuit 60, as described by arrows in FIG. 2, such as from the WB stage to the EXE stage, from the WB stage to the MEM stage, and from the MEM stage to the EXE stage. However, pipeline stages enabling the bypass process varies among the processors 10, not limited to the above example.

Next, the structural hazard is explained. The structural hazard occurs in case that, for example, a plurality of instructions conflict with one another on accessing hardware resources, such as a writing port of the register file 50, memory access port, and the like. For example, in case that accesses to a memory by the IF stage and by the MEM stage occur, the memory access port is under conflict, thus, for example, an instruction fetch process at the IF stage is not performed. That is, the structural hazard occurs. Here, the processor 10, when expecting the occurring of the structural hazard, for example, by providing the inter-lock signal to delay a process at the IF stage by one process cycle, avoids the structural hazard.

Further, the processor 10 may have, in addition to the five pipeline stages described above, a multi-cycle calculation stage for processing a multi-cycle calculation instruction such as a division instruction (DIV instruction) or the like. For such the processor 10, the structural hazard possibly occurs.

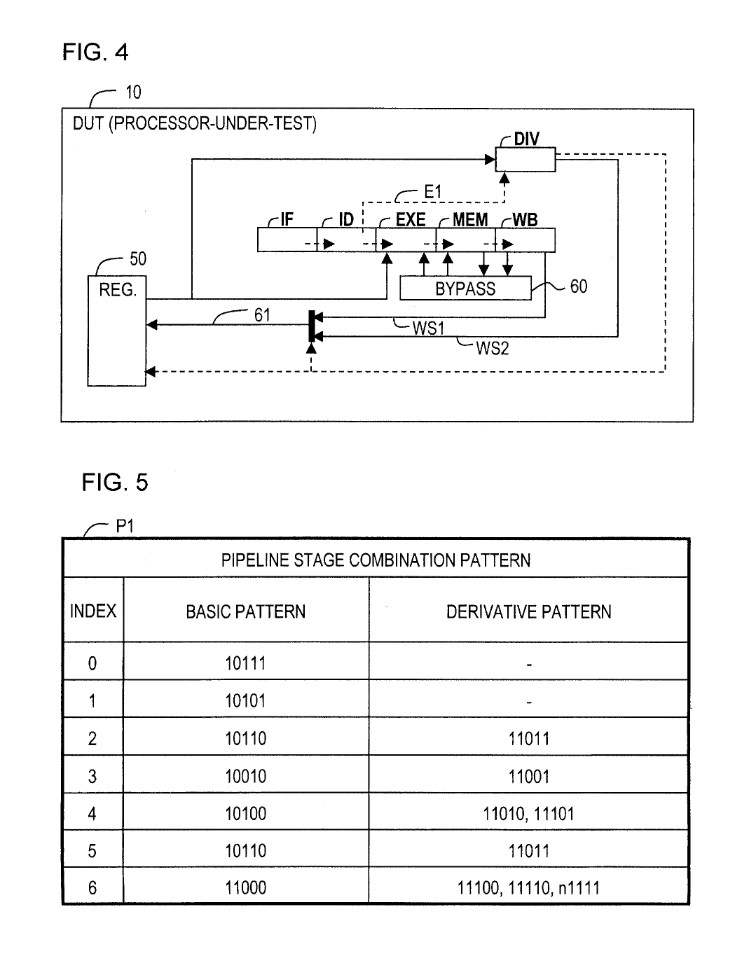

FIG. 4 is a diagram for illustrating an example of an instruction pipeline of the processor 10 having a multi-cycle calculation stage (DIV stage in this example). At the processor 10 of FIG. 4, the DIV instruction transits to the DIV stage (E1) after the ID stage, selects the data bus 61 by outputting a write enable signal after a predetermined number of cycles required for division, and writes the division result WS2 into the register file 50. In this example, the DIV stage and the WB stage use the same data bus 61 and write the calculation result WS1 and WS2 in the register file 50. Therefore, in case that write enable signals are output at the both stages, the structural hazard occurs. Therefore, the processor 10, when the structural hazard is predicted, for example, by providing pipeline stages except for the DIV stage with an inter-lock signal to abort a transition of an instruction, avoids defects due to the structural hazard.

Next, the control hazard is explained. The control hazard occurs, for example, in case that a branching instruction is processed, and that the pipeline process of the subsequent instruction is held until the processed result of the branching instruction is determined. In this case, for example, the processor 10, by providing an inter-lock signal to suspend the fetch process of the subsequent instruction until the branching instruction is processed and a instruction at the branch destination is determined, avoids defects due to the control hazard.

As above, the processor 10 performs the bypass process, or provides the inter-lock signal to pipeline stages to avoid the predicted pipeline hazard (the data hazard, the structural hazard, the control hazard, and the like). For testing such the processor 10, it is necessary to generate the processing status of an instruction at pipeline stages, such that provision of the inter-lock signal and the bypass process occur, and it is necessary to test whether or not the provision of the inter-lock signal or the bypass process is appropriately executed in that processing status. That is, at the timing when the processing status of an instruction at pipeline stages has become the processing status to be tested, a test is performed to see whether or not the provision of the inter-lock signal or the bypass process is appropriately executed. However, for generating such the processing status of an instruction at pipeline stages, tremendous work-processes are required.

Therefore, the processor testing program in accordance with the present embodiment, by referring to a processing status of a pipeline-stage combination pattern (referred to as a “combination patterns”, herein after) indicating the processing status of the instruction to be testesd at the pipeline stage, provides the inter-lock signal to the pipeline stage, while an instruction included in the test instruction sequence is executed, so that a processing status of the instruction at the pipeline stages is matched with the combination pattern, according to an status information at each pipeline stage.

FIG. 5 is a diagram for illustrating an example of a combination pattern table P1 in accordance with the present embodiment. The combination pattern is a combination of information indicating whether or not an instruction is under process at each pipeline stage, and, prescribed previously as the processing status of the instruction to be tested. In this example, each digit of the combination pattern, from the highest-order digit to the lowest-order digit, namely corresponds to the IF stage, the ID stage, the EXE stage, the MEM stage, and the WB stage, wherein “1” represents a status that the instruction is under process (the processing status), and “0” represents a status of not under process (non-processing status). Also, the combination pattern includes a basic pattern and a derived pattern for prescribing the processing status derived from the basic pattern. The processing status of the derived pattern is generated by progression of a transition of the instruction in between the pipeline stages from the processing status of the basic pattern.

In this example, the basic pattern of Index 0, “10111”, indicates the processing status such that the instruction is under process at all the pipeline stages except for the ID stage. And the basic pattern of Index 2, “10110”, indicates the processing status such that the instruction is under process at all the pipeline stages except for the WB stage and the ID stage. The derived pattern of Index2, “11011”, is generated from the processing status of the basic pattern “10110”, by transition of each instruction under process at the pipeline stage and by a new instruction being fetched. The derived pattern of Index6, “11100”, “11110”, and “n1111”, are, in a similar manner, generated one by one by a progress of the transition from the processing status of the basic pattern “11000” and by a new subsequent instruction being fetched. Also, “n” in the derived pattern “n1111” indicates NOP instruction previously included within the test instruction sequence.

Further, in an example of FIG. 5, the derived pattern is generated by the instruction at a pipeline stage transiting from the processing status of the basic pattern and by a new instruction being fetched. The derived pattern also may be generated simply by the instruction at the pipeline stage transiting from the processing status of the basic pattern.

As above, the combination pattern in accordance with the present embodiment includes the basic pattern and the derived pattern, which generated by the processing status of the basic pattern further transiting, and prescribes the processing status to be tested. Thereby, the timing generating unit 30 controls, by providing the inter-lock signal, the processing status of the pipeline stage to coincide with the basic pattern, and generates, by fetching a new instruction and progressing the transition, the processing status to coincide with the derived pattern. That is, the timing generating unit 30 efficiently performs testing process, without a necessity of controlling and generating the processing status at the pipeline stages of the derived pattern from the initial status for each of the all derived patterns one-by-one.

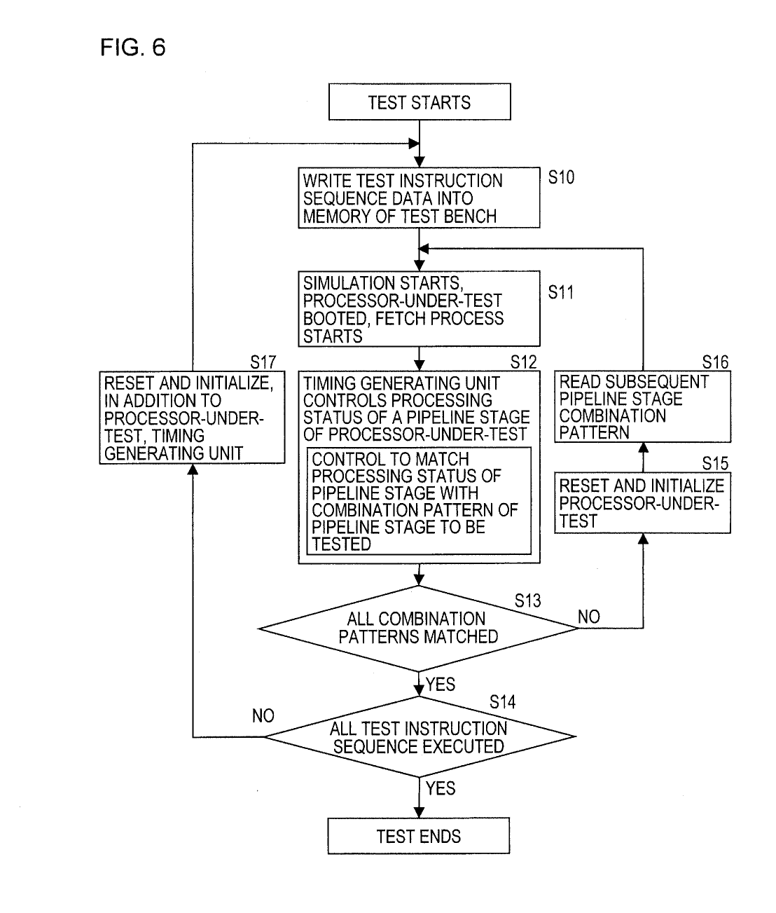

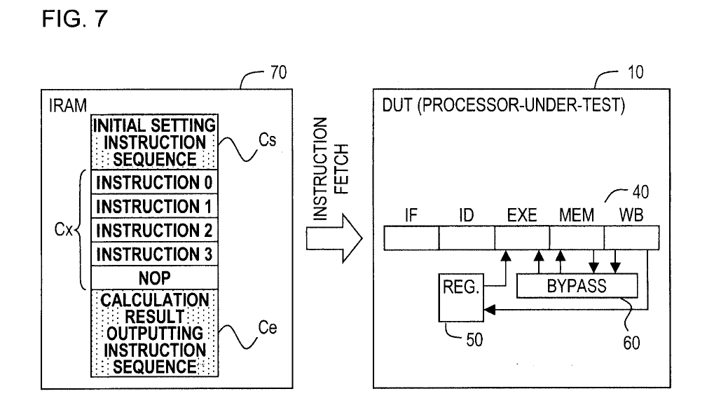

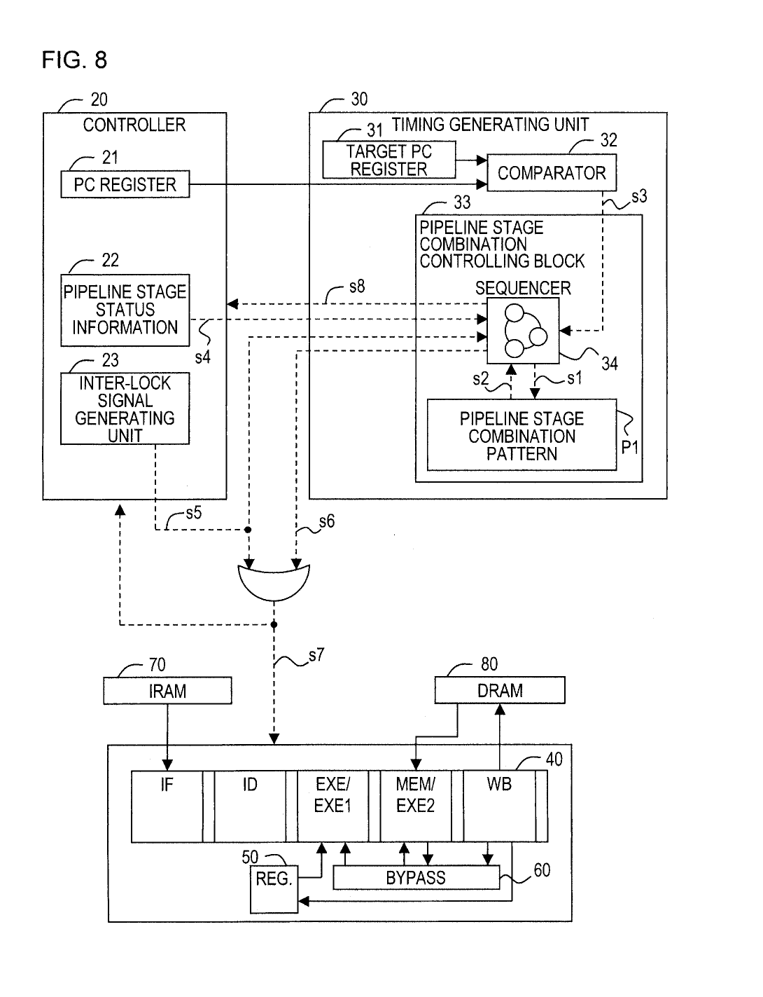

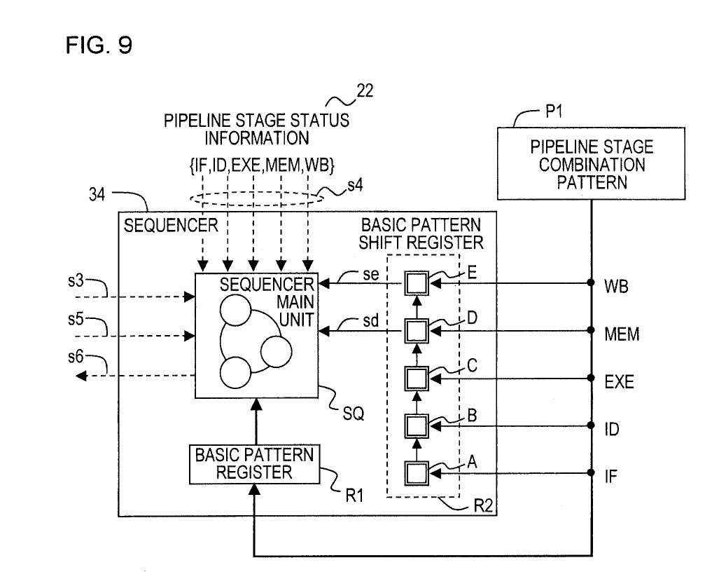

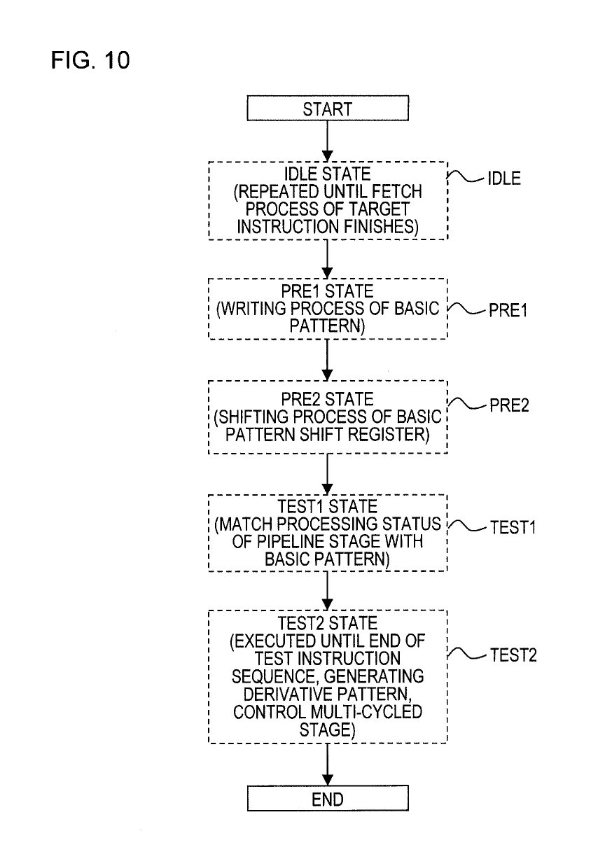

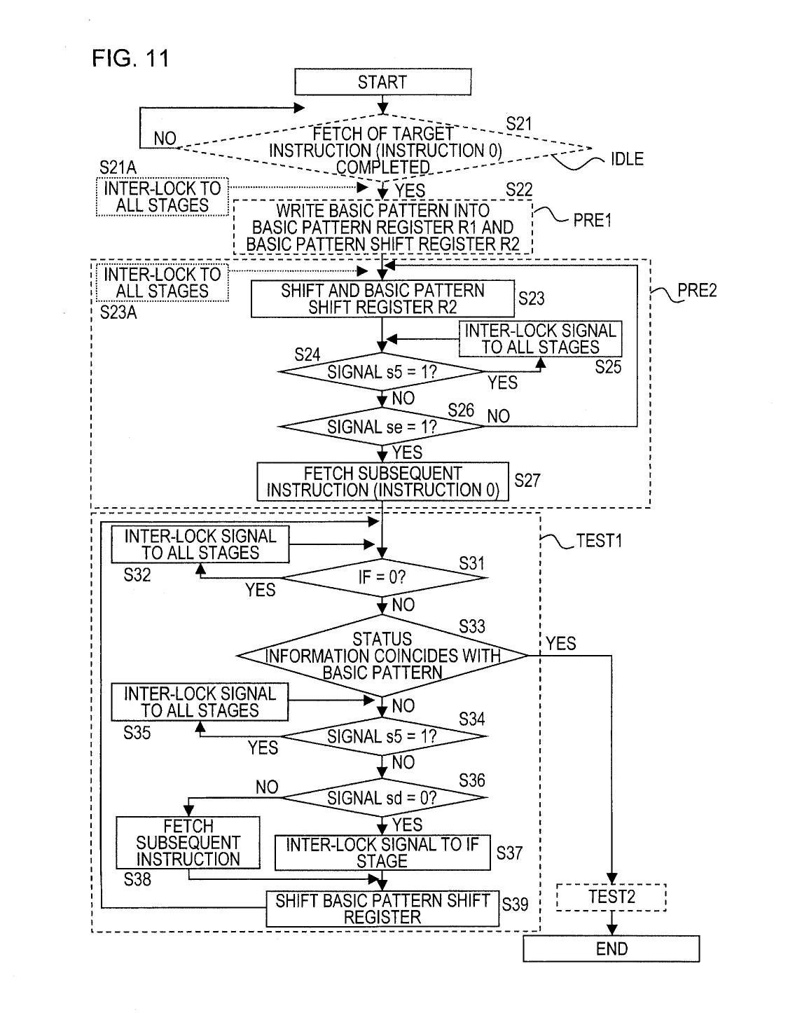

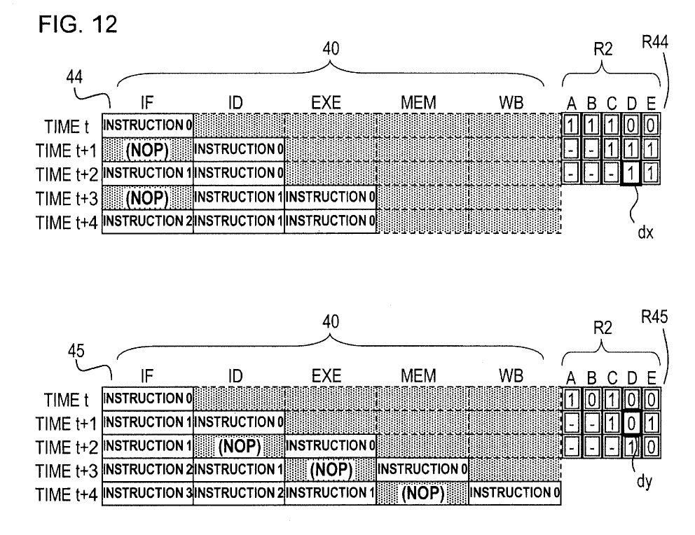

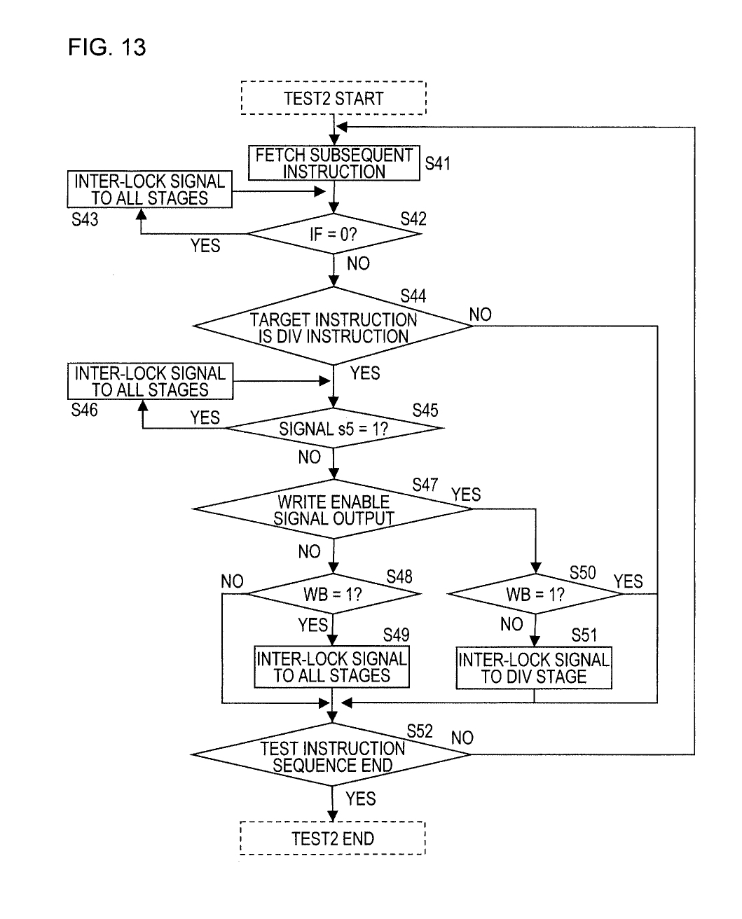

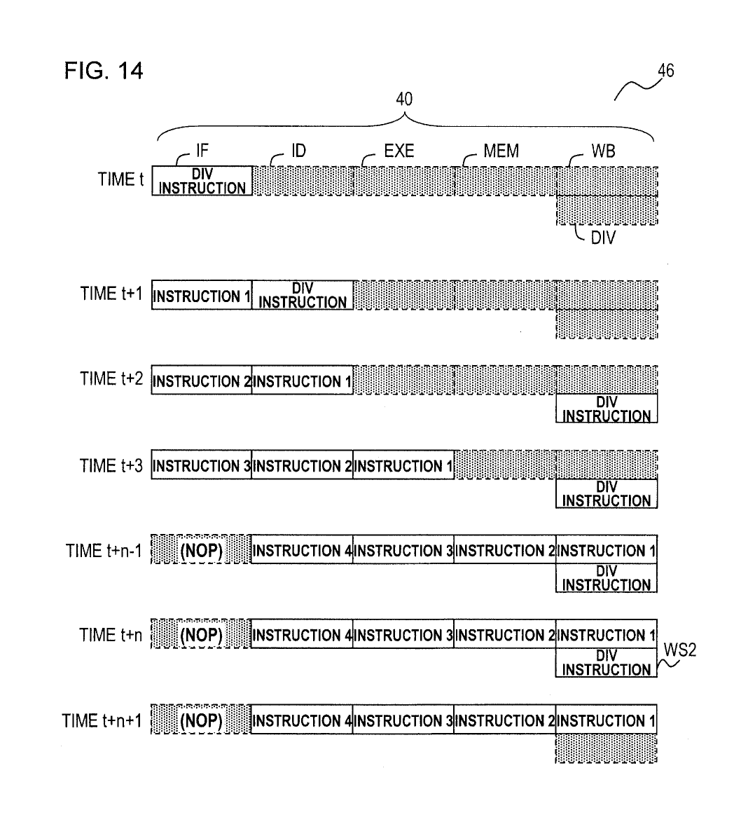

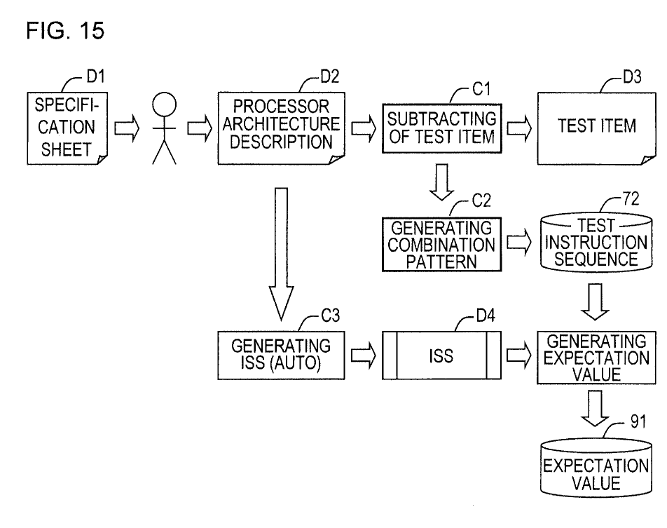

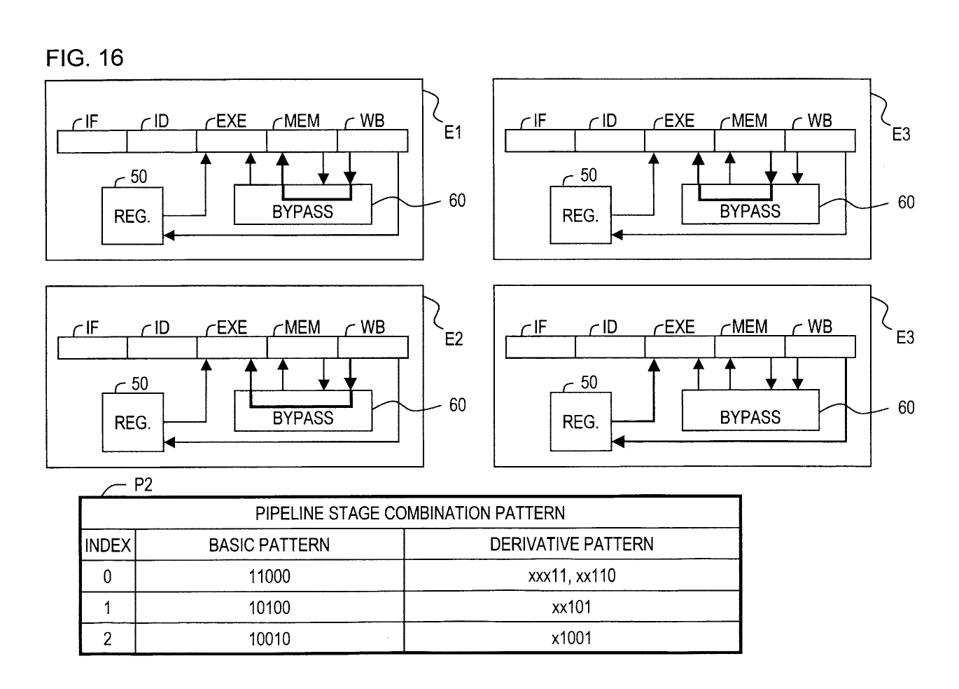

FIG. 6 is a flow-chart diagram for illustrating test procedure of the processor 10 of the test bench 100 of FIG. 1 in accordance with the present embodiment. Firstly, the HDL simulator 205 (FIG. 1), by reading test instruction sequence data 72, writes an instruction code 71 into IRAM70 (FIG. 2), and writes the input data 81 into DRAM 80 (FIG. 2) (S10). Then, the HDL simulator 205 boots the processor-under-test 10, makes the fetch process of the instruction code 71 started, and starts the simulation (S11). The fetched instruction is pipeline-processed, while the timing generating unit 30 controls the processing status of a pipeline stage of the processor-under-test 10 (S12). In this controlling process, the processing status of the pipeline stage is matched with the combination pattern corresponding to the test instruction sequence. Thereby, at the processing status, a processing test of the processor 10 is performed to determine whether or not the inter-lock signal to avoid various hazard is provided, or the bypass process is appropriately performed and so a correct calculation result is output. The detail thereof will be explained below.

Next, matching a processing status of the pipeline stage with a combination pattern (a basic pattern and the derived pattern with regard to the basic pattern), the HDL simulator 205 determines whether or not all the combination patterns are matched with (S13). In case that all the combination patterns are not matched yet (NO at S13), the HDL simulator 205 resets and initializes the processor-under-test 10 (S15), and reads out the subsequent combination pattern from the combination pattern table (S16). Then, the HDL simulator 205 again boots the processor-under-test 10, and makes the fetch process of the instruction of test instruction sequence 72 started (S11).

On the other hand, in case of all the combination patterns are matched (YES at S13), the HDL simulator 205 consecutively determines whether or not all the test instruction sequence 72 are executed (S14). In case that all the test instruction sequence 72 are not executed yet (NO at S14), the HDL simulator 205 resets and initializes, in addition to the processor-under-test 10, the timing generating unit 30 (S17). Then, the HDL simulator 205 reads out the subsequent test instruction sequence 72 from the memory, and performs controls such that all the combination patterns are matched (S10-S14). On the other hand, in case that all the test instruction sequence 72 are executed (YES at S14), the HDL simulator 205 finishes the test.

FIG. 7 is a diagram for illustrating an example of the test instruction sequence 72. The test instruction sequence of FIG. 7 includes an initial setting instruction sequence Cs, an instruction-under-test sequence Cx, and a calculation-result-output instruction sequence Ce. The initial setting instruction sequence Cs is an instruction to perform the initial setting for the test, and the calculation-result-output instruction sequence Ce is an instruction to output the calculation result of the instruction-under-test sequence Cx. The instruction-under-test sequence Cx includes instructions of at most the number of the pipeline stages. Since the processor 10 in accordance with the present embodiment has five-stage instruction pipeline 40, the instruction-under-test sequence Cx includes five instructions. Also, the test instruction sequence 72 has at least the instruction-under-test sequence Cx.

Next, detail of the process at the step S12 of the flow-chart diagram of FIG. 6, that is, the process for matching processing status of the pipeline stage with the combination pattern (FIG. 5) is explained.

FIG. 8 is a diagram for illustrating an example of block diagram of a hardware of the timing generating unit 30 in accordance with the present embodiment. The timing generating unit 30 includes the pipeline-stage-combination controlling block 33, a target PC register 31, and a comparator 32. Also, the pipeline-stage-combination controlling block 33 includes a sequencer 34 and a pipeline-stage combination pattern P1 (FIG. 5). At the target PC register 31, a value of a program counter of the leading instruction of the instruction-under-test sequence Cx of the test instruction sequence illustrated in FIG. 7 is held.

On the other hand, the controller 20 of the processor-under-test 10 of FIG. 8 includes a PC register 21 for holding a value of a program counter of the instruction under process, a pipeline-stage-status information register 22, and the inter-lock signal generating circuit 23. The pipeline-stage-status information 22 is information for indicating whether or not the instruction is under process at each of the pipeline stages of the processor-under-test 10, wherein, in accordance the present embodiment, “0” is for the processing status, and “1” is for non-processing status. The inter-lock signal generating circuit 23 is a circuit for providing, on expecting a occurring of a hazard, an inter-lock signal s5 to the instruction the pipeline stage 40.

When the simulation is started (S11 of FIG. 6), the sequencer 34 of the timing generating unit 30 reads one basic pattern from the combination pattern table P1 (s1, s2). Next, the comparator 32 of the timing generating unit 30 compares the value of the program counter of the instruction under process by the controller 20 with the value of the program counter held by the target PC register 31, and sends a notice to the sequencer 34 in case of matching (s3). That is, the comparator 32 monitors whether or not a process of the instruction-under-test sequence Cx of the test instruction sequence is started.

Receiving the notice (s3), the sequencer 34 obtains from the controller 20 the status information 22 indicating each processing status of the instruction at the pipeline stages (s4). Next, the sequencer, refereeing to the inter-lock signal by the controller 20 (s5), on the basis of the status information 22, provides the inter-lock signal to the instruction pipeline 40 so that the processing status of the pipeline stage coincides with the processing status defined by the basic pattern (s6). This process (s6) will be further explained in accordance with FIG. 9 to FIG. 12.

Then, a logical add of the inter-lock signal (s6) by the sequencer 34 and the inter-lock signal (s5) by the controller 20 is provided as an actual inter-lock signal to each pipeline stage (s7). The timing generating unit 30 provides the inter-lock signal, until the process of the test instruction sequence finishes, on the basis of the pipeline-stage status information 22 from the controller 20 (s4-s7). In case that matching control to all the combination patterns is not completed (NO at S14 of FIG. 6), the timing generating unit 30 outputs a reset signal to the controller 20 (s8, S17 of FIG. 6). Next, the sequencer 34 reads from the combination pattern table P1 the subsequent basic pattern (s1, s2), and performs, in the same manner, the test instruction sequence (s3-s8).

FIG. 9 is a diagram for illustrating a configuration example of the sequencer 34 of FIG. 8. The sequencer 34 is, as illustrated in FIG. 8, input with a comparison result s3, the pipeline-stage status information 22(s4), and the inter-lock signal s5 by the controller 20, and outputs the inter-lock signal s6. Also, the sequencer 34 includes, in addition to a sequencer main unit SQ, a basic pattern register R1 and a basic pattern shift register R2. The basic pattern register R1 holds the basic patterns (s1 and s2 of FIG. 8) read out from the combination pattern table P1, and is used to determine whether or not the processing status of the pipeline stage coincides with the basic pattern. Also, the basic pattern shift register R2 has registers A-E of the number of the pipeline stages. Next, the process flow is explained.

FIG. 10 is a flow-chart diagram for illustrating general outline of a control process of the sequencer main unit (referred to as a “sequencer”, herein after) SQ of FIG. 9. The sequencer SQ in accordance with the present embodiment, as described in a following example, matches the processing status of the pipeline stage with the combination pattern. Here, a case of matching with the basic pattern “10100”, of Index4 of the combination table (FIG. 5) is explained.

1) Firstly, the sequencer SQ detects that the fetch process of the target instruction is executed, according to the comparison result s3. At this time, the processing status of the pipeline stage is “10000”.

2) Next, the sequencer SQ fetches the subsequent instruction, and controls the processing status of the target instruction and the subsequent instruction thereof to into processing status “1” at the IF stage and the ID stage continuously. However, at this time, in case that the fetch process of the subsequent instruction is not completed (a fetch stall occurs), the inter-lock signal is provided so that transition of the target instructions is suspended until the fetch process of the subsequent instruction is finished. Thereby, the processing status (“1”) at the IF stage and the ID stage of the pipeline stage be continuing certainly, and the processing status of the pipeline stages become “11000”. For example, in case of the basic pattern “10100”, the sequencer SQ matches the status information of the pipeline stage having five stages with the basic pattern by transiting the processing status of the pipeline stage as follows.
-) 00000
1) 10000 (the fetch of the target instruction)
2) 11000 (the fetch of the subsequent instruction)
3) 10100 (provision of the inter-lock signal to the IF stage)

3) The sequencer SQ traces the basic pattern“10100” sequentially from the aftermost (right-edge) stage and detects a stage indicating the processing status (“1” in the present embodiment) after having controlled it in a processing status in succession at the IF stage and the ID stage. Then, the sequencer SQ provides the inter-lock signals s6 to the IF stage by the number of the stages of non-processing status (“0” in the present embodiment) adjacent in front (left) of the detected stage. Thereby, by the number of the provided inter-lock signals s6, that is, the number of the stages of non-processing status adjacent in front, the status of stages between the stages, in which the target instruction and the subsequent instruction are processed, become the non-processing status (“0”). In this example, among the basic pattern “10100”, a stage of the processing status “1” is detected at the third stage from the right edge, and to the left thereof, there is one stage of the non-processing status “0”. As such, the sequencer SQ provides the IF stage with the inter-lock signal one time in which the inter-lock signal suspends transiting the subsequent instruction from the IF stage to the ID stage, and controls the processing status of the pipeline stage to “10100” from “11000” by the next transition. This processing status, “10100”, coincides with the basic pattern (10100).

4) as a result of 3), in case of not matching with the basic pattern, processes of 2) and 3) are repeated until the processing status of the pipeline stage coincides with the basic pattern. Thereby, the pattern of the instruction processing status and the instruction of the pattern of non-processing status coinciding with the basic pattern are generated one by one at the IF stage and the ID stage.

In the flow-chart diagram of FIG. 10, the sequencer SQ performs the above processes according to each state of FIG. 10. Firstly, at an IDLE state, the sequencer SQ monitors whether the fetch process of the target instruction is finished or not, by the comparison result s3. Next, at a PRE1 state, the sequencer SQ reads the basic pattern from the basic pattern table P1, and writes it into the basic pattern register R1 and the basic pattern shift register R2 of FIG. 8. Then, the sequencer SQ shifts, at the PRE2 state, the basic pattern shift register R2 for the control process consecutively executed at a TEST1 state.

For example, at the PRE2 state, the sequencer SQ shifts value of each registers A-E of the basic pattern shift register R2 to the extent where the register E becomes the processing status “1”. As a result, the endmost (right edge) stage indicating the processing status “1” in the basic pattern is shifted so as to correspond to the register E. And the stage adjacent in front of the endrnost stage indicating the processing status “1” is shifted so as to correspond to the register D.

Next, at the TEST1 state, the processing status of the pipeline stage is matched with the basic pattern. For example, the sequencer SQ performs a control at the IF stage and the ID stage so that the instructions to be sequentially performed. Then, the sequencer SQ generates such the pattern of the processing status (“1”) or non-processing status (“0”) as to coincide with the basic pattern one by one at the IF stage and the ID stage, by supplying the inter-lock signal to the IF stage when register D (signal sd) is the non-processing status“0” or by not supplying the inter-lock signal when register D (signal sd) is the processing status“1”. That is, after controlling processing status of the instruction into “1” at the IF stage and the ID stage continuously, in case that a value of register D (signal sd) is “0”, as the processing status “1” not being in sequence in the basic pattern, the sequencer SQ provides the IF stage with the inter-lock signal, and generates the processing status “101-” at the pipeline stage. Also, in case that a value of register D (signal sd) is 1″, as the processing status “1” being in a sequence, the sequencer SQ fetches a new subsequent instruction without providing the inter-lock signal, and generates the processing status “111-” at the pipeline stage. Then, whenever the sequencer SQ determines the value of register D and provides the inter-lock signal or fetches the new subsequent instruction, the sequencer SQ shifts a value of each register A-E by one stage. Therefore, the sequencer SQ determines only the value of register D each time. This process is performed, by value of each register A-E being shifted, until the processing status of the pipeline stage coincides with the basic pattern.

At the TEST2 state, the sequencer SQ fetches the test instruction sequence to its last, while avoiding the processing status of the instruction becoming discontinuous at the IF stage and the ID stage due to the fetch stall. Thereby, as illustrated in FIG. 5, the processing status of the derived pattern is generated one by one from the processing status of the basic pattern generated at the TEST1 state, by transiting at the pipeline stage and fetching the subsequent instruction.

FIG. 11 is a flow-chart diagram for illustrating in detail the process at each state. Hereinafter, explanation is made for each state.

[IDLE State]

At the IDLE the state, the sequencer SQ, by the comparison result s3, determines whether or not the target instruction is fetched (S21). For example, the sequencer SQ determines the comparison result (s3 of FIG. 8) of the comparator 32 which compares the program counter of the instruction under process by the processor 10 with the program counter of the Target instruction. In case that the comparison result s3 is asserted (YES at S21), that is, in case of matching, the fetch process of the Target instruction is confirmed, and the sequencer SQ transits to the PRE1 state. At this time, the sequencer SQ provides all the pipeline stages with the inter-lock signal (S21A), and transitions of the instructions at all pipeline stages are suspended. On the other hand, in case that the comparison result s3 is not asserted (NO at S21), the sequencer SQ, without providing the inter-lock signal, continuously determines whether or not the target instruction is fetched.

[PRE1 State]

At The PRE1 state, the sequencer SQ reads the basic pattern, writes it into the basic pattern register R1 and the basic pattern shift register R2, and transits to PRE2 the state (S22). At this time, the sequencer SQ provides all the pipeline stages with the inter-lock signal (S23A), and suspends transitions of the instructions at all the pipeline stage.

[PRE2 State]

Next, at PRE2 the state, the sequencer SQ performs shift process of the basic pattern shift register R2 (S23). For example, the sequencer SQ shifts value held by each of the registers A-E of the basic pattern shift register R2, until the value of register E (signal se) becomes “1”.

At this time, the sequencer SQ determines whether or not the inter-lock signals5 is equal to “1” (S24), that is, whether or not the inter-lock signals5 is generated by the controller 20. In case of the inter-lock signals5 being “1”, that is, in case of occurrence of the inter-lock signals 5 by the controller 20 (YES at S24), the sequencer SQ provides the inter-lock signal to abort transition of the instruction in between all the pipeline stages (S25). As described above, the logical add of the sequencer SQ and the inter-lock signal (s5 and s6) of the controller 20 is provided as the actual inter-lock signal s7 to the pipeline stage. That is, the sequencer SQ, in case of occurrence of the inter-lock signal provided to part of the pipeline stages (s5) by the controller 20, provides all the pipeline stages by itself with the inter-lock signal (s6) to abort transition of the instruction in between not part of the pipeline stages by the controller 20 but all the pipeline stages. Thereby, the sequencer SQ prevents, for the period before the processing status coincides with the basic pattern, the processing status of the pipeline stage from transiting to unanticipated status due to an occurrence of unanticipated the inter-lock signal by the controller 20.

On the other hand, in case of no occurrence of the inter-lock signal s5 by the controller 20 (s5=0, and NO at S24), the sequencer SQ determines whether the first processing status “1”, that detected by following the basic pattern from behind, reaches the register E and the signal se becomes “1”, by shifting. (S26). While the signal se is “0” (NO at S26), the sequencer SQ provides gates of all the pipeline stages with the inter-lock signal (S23A), and the transition of the instruction at all the pipeline stages are suspended. For example, in case of the basic pattern “10100”, of Index4 of FIG. 5, the basic pattern shift register R2 is initially at a status of “A:1, B:0, C:1, D:0, E:0”. Here, the sequencer SQ shifts, until the signal se becomes “1”, wherein the first shift is “A:-, B:1, C:0, D:1, E:0”, and the second shift is “A:-, B:-, C:1, D:0, E:1”.
the basic pattern shift register R2
   the initial status (S22):[A, B, C, D, E]=[1, 0, 1, 0, 0]
   the first shift (S23):[A, B, C, D, E]=[-, 1, 0, 1, 0]
   the second shift (S23):[A, B, C, D, E]=[-, 1, 0, 1]

The first processing status “1” has reached the register E and the signal se has become “1” (YES at S26), the sequencer SQ restarts transition of the instruction at the pipeline stage, and transits to the TEST1 state. Thereby, the Target instruction transits to the ID stage, and the fetch process of the subsequent instruction is performed (S27).

[State: TEST1]

A transition to TEST1 state being performed, the sequencer SQ firstly determines, according to the status information 22 (s4) indicating the processing status of the pipeline stage, whether or not the fetch process of the newly fetched subsequent instruction is completed (S31). In case that the status information 22 (signal s4) of the IF stage is equal to “0” (non-processing status) (YES at S31), the sequencer SQ determines that the fetch process of the subsequent instruction is not completed, that is, the fetch stall occurs. In this case, to control the processing status of the Target instruction and the subsequent instruction into “1” at the IF stage and the ID stage continuously, the sequencer SQ provides all the pipeline stages with the inter-lock signal until fetch of the subsequent instruction is finished (NO at S31, S32). Thereby, at the IF stage and The ID stage, the process of instruction is performed in sequence.

When the processing status of the IF stage has become “1” (processing status), next, the sequencer SQ determines whether or not the status information 22(s4) indicating the processing status of the pipeline stage coincides with the basic pattern held by the basic register R1 (S33). In case of coinciding with the basic pattern (YES at S33), subsequently the sequencer SQ, by fetching a new subsequent instruction, transits to the TEST2 state. On the other hand, in case of not coinciding (NO at S33), the sequencer SQ determines whether or not the inter-lock signal s5 by the controller 20 occurs (S34), and, in case of occurrence (YES at S34), the sequencer SQ provides all the pipeline stages with the inter-lock signal (s6) to abort transition of the instruction in between all the pipeline stages (S35). This process (S34, S35) is in a similar manner to that of the PRE2 state.

Next, in case that the value (signal sd) of the basic pattern shift register R2 of register D after shifting is equal to “0” (non-processing status) (YES at S36), the sequencer SQ provides the IF stage with the inter-lock signal (S37). Therefore, the instruction under process at the ID stage transits to the EXE stage, and, the instruction under process IF stage does not transit to the ID stage because the transition from IF stage is suspended. That is, the sequencer SQ intentionally controls the ID stage to non-processing status at the subsequent transition. On the other hand, in case of the signal sd being equal to “1” (the processing status) (NO at S36), the sequencer SQ fetches a new subsequent instruction (S38). Therefore, the instruction under process at the ID stage transits to the EXE stage, the instruction under process IF stage transits to the ID stage, and, the subsequent instruction newly is fetched at the IF stage. That is, the sequencer SQ controls the IF stage and the ID stage to the processing status“1” at the subsequent transition. That is, the processing status of the pipeline stage becomes same as the processing status that S27 completed. Then, the sequencer SQ shifts the basic pattern shift register R2 by the amount of one stage (S39). Then, the sequencer SQ again returns to determination at the step S31 at the beginning of the TEST1 state. That is, the sequencer SQ performs in a repetition a process at the TEST1 state until the status information coincides with the basic pattern. Here, prior to the explanation of the TEST2 state, processes up to the TEST1 state are explained according to examples.

FIG. 12 is a diagram for illustrating a transition of the processing status of an exemplary pipeline stage and transition of the basic pattern shift register R2. The upper section of FIG. 12 is a transition diagram 44 of the processing status of the pipeline 40 and transition diagram R44 of the basic pattern shift register R2, in case of occurrence of the fetch stall. In this example, the basic pattern under test is, for example, “11100”, which is not illustrated in the combination pattern table P1 of FIG. 5. Also, in this example the leading instruction (The target instruction) of the instruction-under-test sequence in the test instruction sequence is assumed to be the instruction 0, a subsequent instruction thereof is the instruction 1 and the instruction 2. Further, in this example, the fetch stall is assumed to occur at the instruction 1 and the instruction 2, and no inter-lock signal s5 is assumed to be generated by the controller 20.

At the time t of transition diagram 44, if the target instruction (referred to as instruction 0, hereinafter) is fetched (YES at S21 of FIG. 11), the sequencer SQ transits to The PRE1 state. Next, at the time t+1, the sequencer SQ reads the basic pattern “11100”, into the basic pattern register R1, and the basic pattern shift register R2 (S22), and shifts to a status of “A:-, B:-, C:1, D:1, E:1” (S23, YES at S26). Then, after shifting, the processor 10 newly fetches the instruction 1 (S27), and the sequencer SQ transits to the TEST1 state.

After that, the sequencer SQ determines, at the time t+1, whether or not the fetch process of the instruction 1 is completed (S31). In this example, the instruction 0 transits, but because the fetch stall occurs at the instruction 1, the IF stage becomes “0” (YES at S31), and the inter-lock signal is provided (S32), thus transition to the EXE stage of the instruction 0 is aborted and the fetch process of the instruction 1 continues. After that, again, the procedure returns to the determination at the beginning of the TEST1 state. Then, at the time t+2, when the fetch process of the instruction 1 is completed (NO at S31), the instruction 0 and the instruction 1 become the processing status at the IF stage and The ID stage in series.

After that, it is determined whether or not the processing status which coincides with the basic pattern is generated (S33). At the time t+2, the status information 22(signal s4) is such as: the IF stage being equal to “1”, the ID stage being equal to “1”, the EXE stage being equal to “0”, the MEM stage being equal to “0”, and the WB stage being equal to “0” (“11000”). Since the signal s4 “11000” does not coincide with the basic pattern “11100” (NO at S33), determination of the signal sd is consecutively performed (S36). At this time, since the signal sd (dx) at the basic pattern shift register R2 is equal to“1” (NO at S36), the sequencer SQ newly fetches the instruction 2 (S38), and shifts the basic pattern shift register R2 (S39).

Then, again, at the time t+3, the sequencer SQ determines whether or not the fetch process of the instruction 2 is completed (S31). Since, as described above, at the instruction 2, the fetch stall occurs (YES at S31), the fetch process becomes non-completion status. Therfore, the inter-lock signal is provided in a similar manner (S32), and transitions of the instruction 0 and the instruction 1 are aborted and the fetch process of the instruction 2 is continued. Then, at the time t+4, when the fetch process of the instruction 2 is completed (NO at S31), the instructions 0-2 become sequential processing status at the pipeline stage. After that, the sequencer SQ determines whether or not the status information 22(signal s4), “11100”, coincides with the basic pattern, “11100” (S33). And, when the signal s4 coincides with the basic pattern (YES at S33), the sequencer SQ transits to the TEST2 state.

As above, even in case that, for example, unanticipated fetch stall occurs due to condition or the like of the testing environment, the sequencer SQ provides the inter-lock signal to abort transition of the instruction under process after the fetch stall at the pipeline stages (the ID stage through the WB stage) until the fetch process is finished. Thereby, the sequencer SQ controls so that, in between the pipeline stages, the processing status is in sequence from the foregoing instruction to the subsequent instruction thereof. That is, the sequencer SQ avoids the processing status of a pipeline stage transiting to unanticipated status due to an unanticipated fetch stall.

Next, another example is explained. In this example, a case of matching the basic pattern “10100”, of Index4 (FIG. 5), which is described at the beginning part of the explanation about FIG. 10, is explained according to transition diagram 45 in the lower part of FIG. 12. Further, in this example, no fetch stall is assumed to occur, and no inter-lock signal s5 is assumed to be generated by the controller 20.

At the time t in the transition diagram 45 of FIG. 12, when the instruction 0 is fetched (YES at S21), the sequencer SQ transits to the PRE1 state. After that, at the time t+1, the sequencer SQ reads the basic pattern “10100”, into the basic pattern register R1 and the basic pattern shift register R45 (S22), and shifts, as described above, the basic pattern shift register R44 to a status of “A:-, B:-, C:1, D:0, E:1” (S23-S26). Then, the processor 10 newly fetches the instruction 1 (S27), and the sequencer SQ transits to the TEST1 state.

After that, the sequencer SQ determines whether or not the fetch process of the instruction 1 is completed (S31). In this example, as described above, since no fetch stall occurs (NO at S31), the instruction 1 and the instruction 0 become the processing status“1” at the IF stage and the ID stage. Then, the sequencer SQ consecutively determines whether or not the processing status coincides with the basic pattern is generated (S33). At the time t+1, since the status information 22(signal s4) “11000”, does not coincide with the basic pattern “10100” (NO at S33), the sequencer SQ further performs determination process of signal sd of register D (S36). At this time, since signal sd(dy) is equal to “0” (YES at S36), the sequencer SQ provides the IF stage with the inter-lock signal (S37), and shifts the basic pattern shift register R2 (S39).

As a result, at the time t+2, the instruction 0 transits from the ID stage to the EXE stage, while the instruction 1 does not transit from the IF stage. Since the processing status at the IF stage is equal to “1” (NO at S31), at the time t+2, the sequencer SQ consecutively determines whether or not the processing status coinciding with the basic pattern is generated (S33). In this case, the status information 22 (signal s4), “10100”, coincides with the basic pattern “10100” (YES at S33), and the sequencer SQ transits to the TEST2 state. The subsequent process at the time t+3 and time t+4 is the process at the Test2 state.

As above, the sequencer SQ in accordance with the present embodiment, after having processing status of the instruction in between the IF stage and the ID stage in sequence according to the status information 22, by providing the IF stage with the inter-lock signal according to a value of register D (signal sd) of the shifted basic pattern shift register R2, generates one by one the processing status of the pipeline stage coinciding with the basic pattern.

Here, the method for the sequencer SQ controlling the processing status of the pipeline stage so as to coincide with the basic pattern according to the status information 22 is not limited to the above example. Also, the sequencer SQ does not necessarily performs the control in a condition that the processing status of the instruction is in sequential, nor by using the basic pattern shift register R2.

For example, the sequencer SQ fetch a new subsequent instruction and reads the processing status in order from the rearmost stage (in this example, the right edge stage) of the basic pattern. Then, if the read processing status from the basic pattern is non-processing status (“0”) and the ID stage is the processing status (“1”, that is “11-”), the sequencer SQ provides the inter-lock signal to abort transitions of the instructions at the IF stage and the ID stage. Thereby, the processing status at the pipeline stage becomes “110-”. On the other hand, if the read processing status from the basic pattern is the processing status (“1”) and the ID stage is non-processing status (“0”, that is “10-”), the sequencer SQ provides the inter-lock signal to abort transitions of the instructions between all stages after the EXE stage and fetches newly the sequent instruction. Thereby, the processing status at the pipeline stage becomes “11-”. Then, the sequencer SQ reads the processing status of the left-next of the basic pattern and takes a similar step. Thereby, the processing status coinciding with the basic pattern is generated one by one by being judged necessity or not of the new fetch of the subsequent instruction and necessity or not of the supply the inter-lock signal, based on the processing status of the ID stage. As above, the sequencer SQ may provide, according to another method, the inter-lock signal to control the processing status of a pipeline stage to coincide with the basic pattern.

[State: TEST2]

FIG. 13 is a flow-chart diagram for illustrating processes at the TEST2 state. At the TEST2 state, the pipeline process is performed until the last instruction of the test instruction sequence while making the processing status of a pipeline stage matched with the derived pattern from the processing status matched with the basic pattern. Also, in case of the Target instruction (the instruction 0) being a multi-calculation instruction such as division instruction or the like, the sequencer SQ controls the processing status of the pipeline stage to be the processing status on which the structural hazard occurs. For example, at the processor 10 having the DIV stage as in FIG. 4, the sequencer SQ controls the processing status of the pipeline stage so that access to the data bus 61 at the DIV stage and the WB stage simultaneously occur. Further, at the processor 10 of FIG. 4, the write enable signal is output when a process of the DIV stage is finished, and, the subsequent instruction of the DIV instruction may transit the pipeline stage before process of the DIV instruction is finished.

Determination process whether or not the fetch process of the instruction is completed (S42) and process at the fetch stall (S43) are the same as those of the TEST1 state. By the processes of steps S42 and S43, the sequencer SQ prevents the processing status of the pipeline stage from transiting to unanticipated processing status due to an occurrence of the fetch stall. Thereby, the sequencer SQ, by fetching further instruction and progressing transition, has the processing status of the pipeline stage transit from the processing status coinciding with the basic pattern to the processing status coinciding with the derived pattern, while avoiding transition of the processing status due to the fetch stall.

After that, it is determined whether or not the instruction 0 is the DIV instruction (S44). In case of not being the DIV instruction (NO at S44), by the test instruction sequence being pipeline processed until the end (YES at S52), the processing status at the pipeline stage matched with the derived pattern connected with the basic pattern that the processing status matched at the TEST1 state is generated. As the result, a test by one combination of the combination pattern (including the derived pattern that relates to the basic pattern and the basic pattern) and one test instruction sequence is finished.

On the other hand, in case of the Target instruction is the DIV instruction (YES at S44), the structural hazard occurs at the process (S45-S51). That is, it is determined whether or not the signal s5 by the controller 20 is “1” (S45). In the case the signal s5 is equal to “1” (YES at S45), the sequencer SQ provides all the pipeline stage with the inter-lock signal (S46). This determination process is the same as that of the PRE2 state described in accordance with FIG. 11. After that, the sequencer SQ determines whether or not the write enable signal (FIG. 4) is output from the DIV stage (S47). For example, the sequencer SQ detects the write enable signal from the DIV stage, by counting to a cycle required for the processing of the DIV stage after having detected that the DIV stage became the processing status (“1”), based on the status information 22 (signal s4) which includes the processing status at the DIV stage. In case of the write enable signal being output from the DIV stage (YES at S47), the sequencer SQ further determines whether the processing status at the WB stage is “1”. In the case the WB stage is “1” (YES at S50), the write enable signal is output from the WB stage too and the structural hazard occurs. On the other hand, in the case the WB stage is “0” (NO at S50), because a processing at the DIV stage leads, the sequencer SQ provides the DIV stage with the inter-lock signal. Thereby, until the WB stage becomes the processing status, a transition of the instruction of the DIV stage is suspended.

On the other hand, in case of the write enable signal not being output from the DIV stage (NO at S47), and the WB stage being equal to “1” (YES at S48), because the processing at the DIV stage is late, the sequencer SQ provides the inter-lock signal to all the pipeline stages except for the DIV stage. Thereby, until calculation process of the DIV instruction is finished, that is, until an output of the write enable signal from the DIV stage, transition of other instructions under process is suspended.

FIG. 14 is a transition diagram 46 for explaining an example such that the structural hazard is made to occur at the DIV stage and the WB stage. In this example, the Target instruction is assumed to be the DIV instruction, and the basic pattern is assumed to be “11100”. Also, in this case, information for the DIV stage may be stored at the combination pattern. Further, in this example, the signal s5 by the controller 20 is assumed not to be generated, and the write enable signal from the DIV stage is assumed to be output at the time t+n.

The operation of sequencer SQ for controlling the processing status of the pipeline stage to coincide with the basic pattern “11100” from the time t to the time t+3 is the same as the other examples with regard to the IDLE state through the TEST1 state. However, in this example, from the time t+1 to the time t+2, the DIV instruction transits from the ID stage not to the EXE stage but to the DIV stage.

Then, at the time t+n−1, a status is indicated such that the WB stage is equal to “1”, and no write enable signal is output from the DIV stage (NO at S47, and YES at S48). Thereby, the sequencer SQ provides the inter-lock signal to all the pipeline stages except for the DIV stage, and aborts transition of the instruction 1 through the instruction 4. Then, at the time t+n, if the write enable signal is output form the DIV stage with the WB stage being equal to “1” (YES at S47, and YES at S48), the sequencer SQ releases the supply of the inter-lock signal. Thereby, at the DIV stage and the WB stage, accesses to the data bus 61 simultaneously occur, thus the structural hazard occurs.

Here, when the processor 10 works normally, the processor 10 provides, at the time t+n, the inter-lock signals, for example, to all the pipeline stages except for the DIV stage so that no defect by the structural hazard occurs. Then, a user, by confirming that the DIV instruction and the calculation result such as the instruction 0 coincide with the expectation value, determines whether or not the inter-lock signal is provided appropriately at the occurrence of the structural hazard. Further, the case of an occurrence of the structural hazard described in above example is also applicable to a case of occurrence of another hazard at the pipeline stage and at the multi-cycle stage.

As above, the processor testing program in accordance with the present embodiment, as for the test of processor having the multi-cycle calculation stage branching from the pipeline stage (the ID stage), and access the resource same as the WB stage, by providing the inter-lock signal to the pipeline stage according to the status information, generates the processing status of the instruction at the pipeline stage so that at the both stages (the WB stage and the multi-cycle calculation stage) accesses to the resource simultaneously occurs. Thereby, the processing status of the pipeline stage such that various kinds of hazard occurs is generated, and even in case of such a processor having a multi-cycle stage, it is efficiently tested whether or not an appropriate inter-lock signal is provided at the time of occurrence of various kinds of hazard (the structural hazard).

Also, in the above explanation, the timing of completion of calculation process of the multi-cycle stage (the DIV stage) is determined on the basis of the write enable signal from the DIV stage, however, this example does not limit the scope in accordance with the present embodiment. The sequencer SQ may determine the timing of completion of calculation process on the basis of, for example, previously recognized predetermined number of processing cycles of the multi-cycle stage.

As described above, the processor testing program in accordance with the present embodiment provides the inter-lock signal to abort a part or all the transitions of the instruction according to the status information 22 of the pipeline stage, so as to match the processing status of the pipeline stages with the combination pattern which defines the processing status to be tested and indicates whether or not the instruction being under process at each pipeline stage. Thereby, the processing status of the pipeline stage is automatically controlled to previously defined processing status to be tested. Therefore, the user can inspect the movement in a processing status to be tested.

Also, for providing the inter-lock signal at the time of expecting a occurring of various kinds of a hazard, and for testing the processor having the bypass circuit, the user previously defines, as the combination pattern, the processing status of the pipeline stage for each function to be tested, and prepares the test instruction sequence such that each function is tested. Thereby, by multiplying the combination pattern and the test instruction sequence, all test items are covered, and the user efficiently tests each function of the above processor.

Further, the processor testing program in accordance with the present embodiment, in case of occurrence of unanticipated fetch stall due to an environment at the time of the test, provides the inter-lock signal to abort transition of the instruction between the pipeline stages which transit to subsequent to the IF stage. Thereby, the processor testing program prevents processes of the instruction between the pipeline stages from being discontinuous and transiting to unanticipated the processing status due to the fetch stall.

Also, the processor testing program in accordance with the present embodiment, until the processing status of the pipeline stage coincides with the combination pattern, in case of the occurrence of unanticipated the inter-lock signal from the processor 10, provides the inter-lock signal to abort transition of the instruction of all the pipeline stage. Thereby, the processor testing program avoids the processing status of the pipeline stage transiting to the processing status unanticipated, due to unintended inter-lock signal from the processor 10.

FIG. 15 is a drawing for illustrating an example, in case of using the processor testing program in accordance with the present embodiment, of process flow of a generation process of the combination pattern, the test instruction sequence, and the expectation value. In case of using test program for a processor in accordance with the present embodiment, the user easily generates the test instruction sequence and the combination pattern, and the total number of the test instruction sequence is decreased.

Firstly, the user generates an architecture description D2 by high-level language such as LISA and the like, according to a specification sheet D1 of the processor 10. Then, the user subtracts a test item D3 according to generated architecture description D2 (C1). In case of the processor 10 having the bypass circuit 60 as illustrated in FIG. 2, as example of the test item D3, such test items are subtracted as the WB stage to the bypass process of the MEM stage, the WB stage to the bypass process of the EXE stage, the MEM stage to the bypass process of the EXE stage, and the like. After that, the user generates the combination pattern and the test instruction sequence according to the subtracted test item.

Further, the user may generate the expectation value 91, by a simulation in accordance with ISS with the test instruction sequence 72 as an input, according to a module C3 for ISS generated on the basis of the processor architecture D2.

FIG. 16 is a drawing for depicting a generation process C2 of the combination pattern on the basis of the test item. First, E1 in FIG. 16 represents the bypass process from the WB stage to the MEM stage. To test such the bypass circuit 60, the instruction is required to be in the processing status at least at the WB stage and the MEM stage. That is, the processing status of the pipeline stage is required to coincide with “XXX11”. In a similar manner, to test the bypass circuit 60 of E2, from the WB stage to the EXE stage, the processing status of the pipeline stage is required to coincide with “XX101”. And, to test the bypass circuit 60 of E3, from the MEM stage to the EXE stage, the processing status of the pipeline stage is required to coincide with “XX110”. Also, to test a case that the bypass circuit 60 of E4 does not occur, the processing status of the pipeline stage is required to coincide with, for example, “X1001”.

The basic pattern is subtracted on the basis of each subtracted combination pattern, “XXX11”, “XX101”, “XX110”, or “X1001”. In this example, the processing status which the combination pattern “XXX11” shows is a status which the processing status shown by the combination pattern “XX110” further transited. Here, the combination patterns “XX110” and “XXX11” are grouped to be a derived pattern. Then, the pattern (for example “11000”) indicating the processing status of the departure of the transition of the derived pattern “XX110” and “XXX11.” is detected and assumed to be the basic pattern. Also, as for other combination pattern (the derived pattern), as the processing status of departure of the transition of the derived pattern “XX101”, the pattern (for example “10100”) is subtracted and assumed to be the basic pattern. And, as the processing status of departure of transition “X1001”, for example, the basic pattern “10010” is subtracted. Thereby, the combination pattern table P2 in FIG. 16 is generated. Thereby, for the combination pattern, the processing status corresponding to an item to be tested is defined such as the bypass process or the like.

Also, as for generation of the test instruction sequence 72, by the processor testing program in accordance with the present embodiment, for each of the test instruction sequence 72, each combination with all the combination patterns are tested. Thereby, the user classifies the instructions according to the test item D3 such as, for example, existence/non-existence of the bypass circuit 60, existence/non-existence of an access to the resource such as the register file 50, then prepares the test instruction sequence 72 corresponding to the test item D3, by one pattern or so, as a template. Then, each of the templates of the test instruction sequence 72 and the combination pattern being combined, and each of the combination being tested, all the test items D3 are covered. Thereby, comparing to a test, such that generating the test instruction sequence one-by-one so that test item D3 is tested each, the user decreases work-processes required for generating the test instruction sequence 72 and total number of the test instruction sequence 72, thus work-processes for testing the processor 10 being decreased.

Further, the user may execute the above generating process of the test instruction sequence and the combination pattern by using a tool or the like, to further decrease work-processes required for testing.

All examples and conditional language recited herein are intended for pedagogical purposes to aid the reader in understanding the embodiments and the concepts contributed by the inventor to furthering the art, and are to be construed as being without limitation to such specifically recited examples and conditions, nor does the organization of such examples in the specification relate to a showing of the superiority and inferiority of the embodiments. Although the embodiments have been described in detail, it should be understood that the various changes, substitutions, and alterations could be made hereto without departing from the spirit and scope of the invention.

What is claimed is:

1. A non-transitory computer-readable medium storing a processor testing program causing a computer to execute a testing process for a processor, the processor having a plurality of pipeline stages for processing an instruction and a controller for providing the pipeline stage with an inter-lock signal for aborting a transition of the instruction between the pipeline stages when a pipeline hazard is expected to occur,
the testing process comprising:
referring to a pipeline-stage combination pattern indicating whether or not an instruction is under process at each pipeline stage and prescribes a processing status to be tested at the pipeline stages; and
timing generating which provides the inter-lock signal to the pipeline stage, while an instruction included in a test instruction sequence is executed, so that a processing status of the instruction at the pipeline stages is matched with the processing status to be tested of the pipeline-stage combination pattern according to an status information indicating whether or not the instruction is under process at each pipeline stage.

2. The non-transitory computer-readable medium storing the processor testing program according to claim 1, wherein
the plurality of the pipeline stages have a first and a second stages,
the processor has a bypass circuit which bypasses a calculation result of the first stage to the second stage, and
the pipeline-stage combination pattern has a pipeline-stage combination pattern which indicates the instruction being under process at both of the first and the second stages.

3. The non-transitory computer-readable medium storing the processor testing program according to claim 1, wherein
the plurality of the pipeline stages have a third stage, and a fourth stage to which an instruction transits from the third stage and which accesses to a shared resource with the processor, and a fifth stage to which an instruction branches from the third stage without transiting to the fourth stage, the fourth stage processing an instruction requiring a plurality of cycles for processing and accessing to the shared resource at the end of the processing of the instruction, and
the timing generating provides the inter-lock signal to the pipeline stage so that the processing status of the instruction at the pipeline stages is matched with the processing status to be tested of the pipeline-stage combination pattern, in which an access to the shared resource simultaneously occurs at the fourth and the fifth stages.

4. The non-transitory computer-readable medium storing the processor testing program according to claim 1, wherein
the testing process is executed for all the pipeline-stage combination patterns about each of a plurality of test instruction sequences.

5. The non-transitory computer-readable medium storing the processor testing program according to claim 1, wherein
the pipeline-stage combination pattern has a basic pattern, and a derived pattern prescribing a processing status to be tested generated by a transition of the instructions between the pipeline stages from a processing status of the basic pattern, and
the timing generating matches the processing status of the instruction at the pipeline stages with the derived pattern, by the transition of the instructions after matching the processing status of the instruction at the pipeline stages with the basic pattern, while the instruction included in the test instruction sequence is executed.

6. The non-transitory computer-readable medium storing the processor testing program according to claim 1, wherein
the plurality of the pipeline stages have a fetch stage for performing a fetch process of the instruction, and
the timing generating provides the inter-lock signal to the pipeline stage to suspend the transition of the instruction of a pipeline stage subsequent to the fetch stage until the fetch process of the instruction is completed at the fetch stage.

7. The non-transitory computer-readable medium storing the processor testing program according to claim 1, wherein
the timing generating provides the inter-lock signal to the pipeline stage to abort all the transitions of the instruction between all the pipeline stages, when a inter-lock signal is provided to a certain pipeline stage by the processor.

8. The non-transitory computer-readable medium storing the processor testing program according to claim 1, wherein
the testing process performs the timing generating while the computer executing the processor which is described by a Hardware Description Language.
